(19) United States
(12) Patent Application Publication
(10) Pub. No.: US 2009/0177483 A1
(43) Pub. Date: Jul. 9, 2009

(54) System and method for facilitating the establishment and operations of a professional service organization

(76) Inventors: Bret K. Bocook, Washington, DC (US); Douglas Smurr, Alexandria, VA (US)

Correspondence Address: PCT LAW GROUP, PLLC, 818 CONNECTICUT AVENUE, NW, SUITE 700, WASHINGTON, DC, 20006, US

(21) Appl. No.: 12/008,243

(22) Filed: Jan. 9, 2008

(51) Int. Cl. G06Q 99/00

(52) U.S. Cl. 705/1

(57) ABSTRACT

A system and method of facilitating the establishment and operations of a professional services organization governed by rules of professional conduct that prohibit obtaining investments from non-licensed investors. The method compromises establishing a stand-alone, turn-key solution company to provide necessary services to one or more professional service organizations. These services are paid for by the professional service company and classified as expenses, not profit sharing which is prohibited by various jurisdictions' rules of professional conduct or codes of professional responsibility. The turn-key solution company is then able to be owned by shareholders who are not themselves licensed professionals. This results in outside equity investments with predictable cash flow and returns without running afoul of any applicable professional codes or rules. Such capital infusion allows the professional services entity to grow and capture market share in a manner that would be highly difficult or impossible solely through organic or internal funding.

### BACKGROUND OF THE INVENTION

1. Field of the Invention

The present invention generally relates to establishing and operating a professional service entity, and more particularly to systems and methods for facilitating the establishment and operations of such entities to provide access to capital while ensuring the professional independence of the members of such entities.

2. Related Art

In today's regulatory environment, it is not possible for professional service (e.g., law, engineering, medical, chiropractic, accounting, architectural and the like) firms or companies to attract outside investors. That is, such professional service companies have traditionally been subject to state and other jurisdictional rules and/or regulations that hamper receiving equity investments from investors. For example, the American Bar Association's Model Rules of Professional Conduct, Rule 5.4 states in relevant part that “a lawyer or law firm shall not share legal fees with a nonlawyer,” and “A lawyer shall not form a partnership with a nonlawyer if any of the activities of the partnership consist of the practice of law.”

These model rules are very influential and have been adopted by almost every jurisdiction (in some form or another) in the United States as either “rules of professional conduct” or “codes of professional responsibility.” For example, the Board of Governors of the State Bar of California and the Supreme Court of California have adopted Rules of Professional Conduct 5.4 which states that “a lawyer or law firm shall not share legal fees with a nonlawyer.”

The Illinois Rules of Professional Conduct, Rule 5.4(d)(1) states that “a lawyer shall not practice with or in the form of a professional corporation or association authorized to practice law for a profit, if . . . a nonlawyer owns any interest therein.”

New York Lawyer's Code of Professional Responsibility, DR 3-102, states “[a] lawyer or law firm shall not share legal fees with a non-lawyer,” and DR 3-103 states “[a] lawyer shall not form a partnership with a non-lawyer if any of the activities of the partnership consist of the practice of law.”

The Florida Rules of Professional Conduct, Rule 4-5.4(e) states: “A lawyer shall not practice with or in the form of a business entity authorized to practice law for a profit if: (1) a nonlawyer owns any interest therein . . . (2) a nonlawyer is a corporate director or officer thereof . . . or (3) a nonlawyer has the right to direct or control the professional judgment of a lawyer.”

Similar professional rules and statues have been adopted by various states and jurisdictions and also apply in some shape or fashion to non-law firm professional services (e.g., engineering, medical, chiropractic, accounting, architectural and like services). The stated purpose of these rules is “to protect the lawyer's professional independence of judgment.” (District of Columbia Rules of Professional Responsibility, Rule 5.4, Comment 1). Comment No. 2 to the District of Columbia Rules of Professional Responsibility, which governs the practice of law in the U.S. capital city, observes: “Traditionally, the canons of legal ethics and disciplinary rules prohibited lawyers from practicing law in a partnership that includes nonlawyers or in any other organization where a nonlawyer is a shareholder, director, or officer.” That is, the aforementioned regulations have been promulgated due to the public policy of needing to keep professional service providers objective in their advice and delivery of their respective services, without being beholden to outside financial pressures from investors who are more concerned with on a return on their investment, than the rendering of unbiased professional advice to clients.

Given the foregoing regulatory environment, equity investments in law firms by “outsiders” such as angels, venture capital firms, private equity firms, institutional investors, high net worth individuals and other private investors are impossible. Equity investments, however, are the means by which all other non-professional services, start-up companies raise money to enter into business. This capital restraint has prevented professional service firms from obtaining the sometimes massive, equity-funded growth that companies that are not constrained by such investment restrictions can experience.

In business, to grow a company without the benefits of outside capital requires the company to be “organically grown,” or to grow using “partner money” (i.e., internal funding from the partners who comprise the professional service firm and must all share the same licensure to practice in the regulated, professional field). Either way, organic growth or partner money is oftentimes insufficient to compete in the marketplace. That is, one of the main disadvantages of having to grow through partner money is that a professional service firm is not able to capture massive market share or name recognition. Therefore, such firms grow at slow rates, and rarely are able to capture market share in multiple jurisdictions or professions.

The above-described problem can be illustrated in another fashion. In today's corporate environment, momentum and market share are major contributors to the success of a company. For example, certain industries typically have dominant companies that capture incredible market share within a short period of time. Such industries include the internet search engine industry with such players as Google and Yahoo!. Another example includes the overnight courier industry where FedEx was able to roll out operations and set up subsidiary or satellite operations in multiple locations in a manner that allowed its business to function and expand rapidly. It could be argued that FedEx would never have come to be a dominant player if it were constrained by the types of regulations restricting outside investors that constrain professional service firms. Nor could FedEx's business model function if it were constrained by limited coverage or scope if it had to rely solely on organic growth to fund its operations. Two or three, or even ten pick up locations for FedEx would not allow its business model to function. Outside investors were critical to FedEx's success to roll out its operations concurrently in multiple markets.

A solution to the above-described problem oftentimes used by professional service firms is to borrow (i.e., take on debt), which is not as tightly regulated by “rules of professional conduct” or “codes of professional responsibility” as equity investments. However, typical venture capitalists and private investors are looking for returns that are often 100 times their initial investment and only invest in companies that offer that potential. Interest rates that are the market norm for loans (e.g., 2-7%), however, offer nowhere near the return that equity investments offer to investors. This severally limits the amount of debt capital available to be loaned to regulated professional service firms and such debt, when available, is usually lent by a local bank that does not have the tolerance for risk that equity investors can justify through the potential of the blockbuster returns mentioned above.

Given the foregoing, what is needed is a system and method for facilitating the establishment and operations of a professional service organization such that outside equity investments may be received and used by such organization to finance its operations within the existing (and restrictive) regulatory framework described above.

### BRIEF DESCRIPTION OF THE INVENTION

The present invention meets the above-identified needs by providing a system and method for facilitating the establishment and operations of a professional service (e.g., law, engineering, medical, chiropractic, accounting, architectural and the like) firm such that outside equity investments may be received and used by such an organization to finance its operations within the existing (and restrictive) regulatory framework where, for example, “a lawyer shall not form a partnership with a non-lawyer if any of the activities of the partnership consist of the practice of law.”

The method, in an embodiment, comprises receiving investment capital into a services company from a plurality of investors and the entering into a services agreement between the services company and a professional service firm, wherein the services company provides all the services needed to operate the professional service firm. Then, the services company receives payment from the professional service firm for rendering the services and can then pay the plurality of investors at least a portion of the payment received from the professional services company in the form of a stock dividend or partnership distribution. The methodology takes place wherein the plurality of investors are not necessarily licensed to practice the professional service provided by the professional service firm, and wherein the jurisdiction promulgates at least one regulation prohibiting non-licensed persons from being members in the professional service firm.

In an embodiment, the present invention is a computer program product capable of receiving information about the amount of investment capital invested into the services company from the plurality of investors. The computer program product would also be capable of determining a payment amount due to the services company for rendering at least one of the plurality of services needed to operate the professional service firm, and determining the distribution amount payable to each of the plurality of investors based in part upon the payment amount due to the services company for rendering at least one of the plurality of services to the professional services firm.

An advantage of the present invention is that it allows outside equity investors—who may be (most likely) wholly unlicensed or simply unlicensed in the relevant jurisdiction(s)—to invest in regulated professional services firms.

Another advantage of the present invention is that it allows a newly-started professional service firm to more quickly capture market share, name recognition and momentum on a multiple market basis through economies of scale to compete with larger, more established firms; wherein such economies of scale may be passed on to consumers (i.e., the clients of the professional service firm), further enhancing growth.

Another advantage of the present invention is that it allows a newly-started professional service firm to avoid the traditional route of debt financing in order to obtain capital to launch, operate and grow the firm.

Yet another advantage of the present invention is that it allows for predictable and profitable cash flow and substantial returns to investors to entice them into investing in a professional services firm, all while respecting the public policy rationale of objectivity and independence of professionals giving advice to clients and professional responsibility guidelines governing such professionals licenses.

Yet another advantage of the present invention is that the business arrangement between the turn-key solution provider company and the professional service firm can be duplicated in multiple jurisdictions, allowing the professional firm to expand at a much greater rate than would normally be possible without the capital constraints on operations curtailing such growth.

Yet another advantage of the present invention is that it promotes good public policy by allowing professional companies to experience economies of a scale, all of which will be passed on to consumers in their utilization of such professional services, and thus ultimately provide more access to such practicing professionals.

Yet another advantage of the present invention is that it promotes good public policy by allowing professional companies to operate at lower costs and therefore provide professional services to individuals and businesses whose needs are currently not served except by very limited pro bono work (i.e., professional services undertaken voluntarily and without payment), or by public assistance centers such as low-income or indigent law clinics and the like.

Further features and advantages of the present invention, as well as the structure and operation of various embodiments of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an exemplary system and method for facilitating the establishment and operations of a professional service firm according to an embodiment of the present invention.

FIG. 2 is a block diagram of an exemplary computer system useful for implementing the present invention.

### DETAILED DESCRIPTION

The present invention is directed to a system and method for facilitating the establishment and operations of a professional service (e.g., law, engineering, medical, chiropractic, accounting, architectural and the like) organization.

In an embodiment of the present invention, a corporate structure is established enabling regulated law firms or individual lawyers to accept outside equity investments from passive, non-licensed investors (i.e., non-lawyers) in a manner that provides for the investors' capital to go to a corporate entity that provides a plurality of turn-key services to the law firms or individual lawyers that they would otherwise receive from multiple third-party sources; all while: (a) allowing for the investors to receive a return on their investment; and (b) respecting the objectivity and independence of the legal professionals giving advice to their clients and any applicable professional responsibility guidelines governing the professional licenses (i.e., state bar licenses) of the attorney(ies).

The present invention is now described in more detail herein in terms of the above exemplary legal professional services context. This is for convenience only and is not intended to limit the application of the present invention. In fact, after reading the following description, it will be apparent to those skilled in the relevant art(s) how to implement the following invention in alternative embodiments (e.g., engineering, medical, chiropractic, accounting, architectural and like regulated, professional service firms).

The terms “entity,” “organization,” “firm,” “company,” “business,” “individual” and/or the plural form of these terms are used interchangeably throughout herein to refer to those person(s) or entity(ies) offering professional (e.g., law, engineering, medical, chiropractic, accounting, architectural, etc.) services and would benefit from the system and method that the present invention provides for facilitating the establishment and operations of such entities.

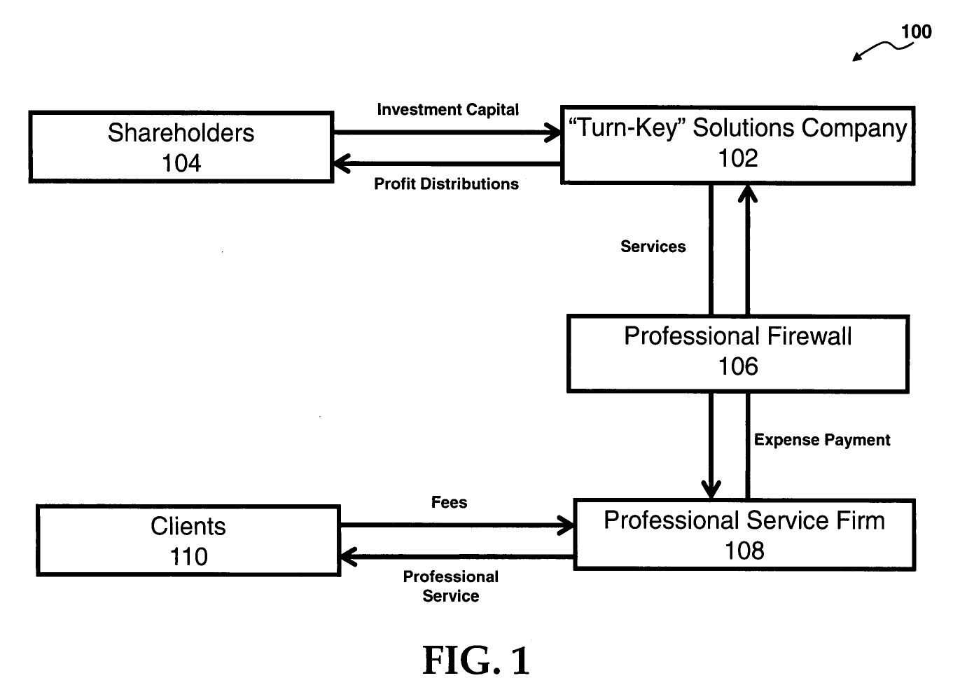

Referring to FIG. 1, a block diagram illustrating an exemplary system 100 and method for facilitating the establishment and operations of a professional service firm, according to an embodiment of the present invention, is shown.

System 100 includes a traditional, stand-alone, for-profit entity 102 which, in alternate embodiments, may take the legal form of an S corporation, a C corporation, a limited liability company, a sole proprietorship or any legal entity that may be owned by one or more outside (non-licensed) investors 104. As will be appreciated by those skilled in the relevant art(s), investors 104, in alternate embodiments, may include one or more angel investors, venture capital firms, private equity firms, institutional investors, (high net worth) individuals and any other private investors (referred to sometimes herein individually as “shareholder,” and collectively as “shareholders”), seeking scaleable and predictable returns in the form of cash flow (i.e., dividends) and/or capital appreciation from their equity investment into the traditional, stand-alone, for-profit entity 102. As will be appreciated by those skilled in the relevant art(s) after reading the disclosure herein, shareholders 104 need not be licensed professionals.

In an embodiment, traditional, for-profit entity 102 is structured as a “turn-key solution” company capable of providing one or more professional service firms (e.g., law firm) 108 with a host of services that professional service firm 108 would otherwise have to pay to independent, third-party vendors. Such services, in alternate embodiments, would include: real estate leasing services; furniture rental; computer and information technology (IT) equipment services; support personnel (e.g., IT, secretary, mailroom and paralegal) staffing; office administration services; recruiting and employment administration; compliance services; performance management; health, dental and other benefits management; training and development services; hardware, software and other intellectual property licensing services; and like business services.

That is, in one embodiment, turn-key solution company 102 would provide professional service firm 108, via a contractual relationship (i.e., an outsourcing agreement, a services agreement, etc.), with all the services and staff needed to successfully establish and operate firm 108—with the exception of the actual licensed professionals (i.e., the attorneys) engaging in the practice of law. In one embodiment, as will be appreciated by those skilled in the relevant art(s) after reading the disclosure herein, firm 108 would have no employees, lease, furniture or any other liabilities, except for the service contract with turn-key solution company 102.

As will be appreciated by those skilled in the relevant art(s) after reading the disclosure herein, however, the staff provided by turn-key solution company 102 to professional service firm 108 would be working directly under the control of the licensed professionals.

In an embodiment where turn-key solution company 102 would provide professional service firm 108, via a contractual (outsourcing services) relationship, with one or more services, firm 108 would pay turn-key solution company 102 for all such services as a single expense rather than paying a plurality of vendors.

In alternate embodiments, professional service firm 108 may take the legal form of a limited liability partnership (LLP), a professional limited liability corporation (PLLC), a professional corporation (PC), sole proprietorship or any legal form the jurisdiction in which firm 108 is located allows licensed professionals to offer professional services to the public (i.e., one or more clients 110) and in which the members (i.e., partners/owners) of firm 108 must each possesses a professional license to engage in the professional relevant service.

In an embodiment, a professional firewall 106 is implemented between firm 108 and turn-key solution company 102 such that to insure that firm 108 stays in conformance with the applicable rules of professional conduct or codes of professional responsibility. That is, firewall 106 is a set of (contractual) rules of engagement between firm 108 and turn-key solution company 102 that draws “bright lines” to assure that: (a) company 102 is a stand-alone company where its shareholders 104 may not participate in the profits of firm 108; (b) states that the licensed professionals practicing within firm 108 must maintain complete objectivity and have no pressures from outside investors 104; (c) the relationship between turn-key solution company 102 and firm 108 is one of vendor-to-vendor; (d) the turn-key services provided by company 102 are market driven and “arms length” to firm 108 at all times; (e) recognize that although there may be a perceived symbiotic relationship between the two entities, such a relationship must not in any way taint the advice given to the clients 110 of firm 108; and (f) recognizes that company 102 and investors 104 will not interfere in, nor be privy to, the trusted (e.g., attorney/client, doctor/patient, etc.) communications between client 110 and the professionals who are members of firm 108.

As will be appreciated by those skilled in the relevant art(s) after reading the disclosure herein, the capital raised from shareholders 104 by turn-key solutions company 102 will be used to create the infrastructure needed to provide the turn-key services to one or more professional services firms 108. In turn, as turn-key solutions company 102 provides services for one or more professional services firms 108, it earns a market-driven, “arms length” service fee which is an expense to firm 108. Thus, the profit of firm 108 is simply the professional (e.g., per hour or contingency) fees charged to its clients, minus the fees paid to turn-key solution company 102. Accordingly, the public policy of barring outside investors 104 from investing, and subsequently pressuring and tainting the professional advice given to clients 110 is eliminated by the fact that the profits of firm 108 are not shared, and the vendor-to-vendor relationship is respected. However, this coordinated, mutually-beneficial investment structure 100, allows outside investors 104 to achieve predicable returns (that could be extremely large) as company 102 expands, while providing the critical services in a turn-key manner that that in the prior art would constrain the growth of firm 108.

In sum, as a result of system 100 and the methods of facilitating the establishment and operations of a professional service firms of the present invention, a predictable and profitable cash flow and substantial returns to shareholders 104 is achieved such to entice them into investing in turn-key solution company 102. Accordingly, the capital restraints experienced by professional service organizations 108 that constrain their ability to bring in outside investors is substantially mitigated and solved, while still respecting the public policy rationale of objectivity of licensed professionals giving advice to clients 110 and the professional responsibility guidelines governing such licensed professionals.

The present invention (i.e., system 100, the methods of facilitating the establishment and operations of a professional services firm of the present invention, or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

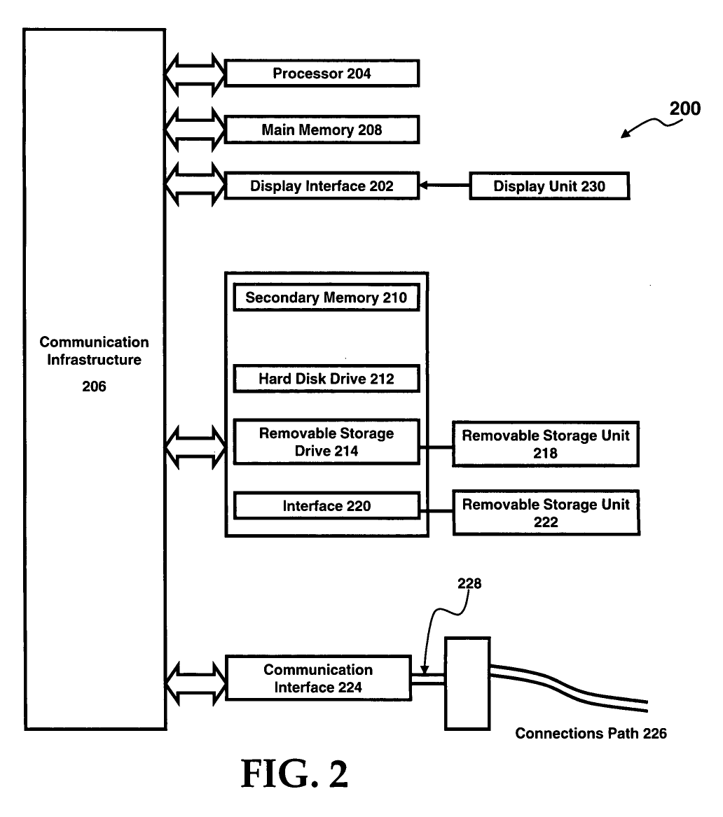

In fact, in one embodiment, the invention is directed toward one or more computer systems capable of carrying out the functionality described herein. An example of a computer system 200 is shown in FIG. 2.

The computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230.

Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 214, a hard disk installed in hard disk drive 212, and signals 228. These computer program products provide software to computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212 or communications interface 224. The control logic (software), when executed by the processor 204, causes the processor 204 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A method for facilitating the operations of a professional service firm comprised of members who each possesses a license required and issued by a jurisdiction to engage in a professional service, comprising the steps of:
(a) receiving investment capital into a services company from a plurality of investors;
(b) entering into a services agreement between said services company and said professional service firm, wherein said services company provides a plurality of services needed to operate said professional service firm;
(c) receiving payment for rendering at least one of said plurality of services from said professional service firm; and
(d) paying said plurality of investors at least a portion of said payment received from said professional services company for rendering said at least one of said plurality of services;
wherein said plurality of investors are not necessarily licensed to practice said professional service provided by said professional service firm; and
wherein said jurisdiction promulgates at least one regulation prohibiting non-licensed persons from being members in said professional service firm;
whereby the members of said professional service firm benefit from said investment capital without running afoul of said at least one regulation.

2. The method of claim 1, wherein said professional service firm is one of: a law firm; an engineering firm; a medical practice; a chiropractic practice; an accounting firm; and an architectural firm.

3. The method of claim 1, wherein said plurality of services includes at least one of: real estate leasing services; furniture rental services; IT equipment leasing services; furniture rental services; support personnel staffing services; intellectual property licensing services; office administration services; recruiting services; benefits management services; and training services.

4. The method of claim 1, wherein said professional service firm is a law firm and each member of said law firm is a licensed attorney.

5. The method of claim 4, wherein step (b) comprises the step of:
preserving the attorney-client privilege status of a communications between one of the members of said law firm and a client of said law firm.

6. The method of claim 4, wherein said jurisdiction further promulgates at least one regulation prohibiting non-lawyers from sharing fees with the members of said law firm.

7. The method of claim 6, wherein said plurality of investors includes at least one of: an angel investor; a venture capital firm investor; a private equity firm investor; an institutional investor; and an individual investor.

8. The method of claim 6, wherein step (d) comprises:
paying said plurality of investors at least a portion of said payment received from said professional services company for rendering said at least one of said plurality of services in the form of a stock dividend.

9. The method of claim 6, wherein step (d) comprises:
paying said plurality of investors at least a portion of said payment received from said professional services company for rendering said at least one of said plurality of services in the form of a partnership distribution.

10. A method for operating a professional service firm comprised of a plurality of members who each possesses a license required and issued by a jurisdiction to engage in a professional service, comprising the steps of:
(a) entering into a services agreement with a services company, wherein said service company provides a plurality of services needed to operate said professional service firm; and
(b) paying said services company for rendering at least one of said plurality of services to said professional services firm;
wherein the owners of said services company are not licensed to practice said professional service provided by said plurality of members who comprise said professional service firm; and
wherein said jurisdiction promulgates at least one regulation prohibiting non-licensed persons from being members in said professional service firm;
whereby the members of said professional service firm benefit from the investment capital provided by the owners of said services company without running afoul of said at least one regulation.

11. The method of claim 10, wherein said professional service firm is one of: a law firm; an engineering firm; a medical practice; a chiropractic practice; an accounting firm; and an architectural firm.

12. The method of claim 10, wherein said plurality of services includes at least one of: real estate leasing services; furniture rental services; IT equipment leasing services; furniture rental services; support personnel staffing services; intellectual property licensing services; office administration services; recruiting services; benefits management services; and training services.

13. The method of claim 10, wherein said professional service firm is a law firm and each of said plurality of members is an attorney licensed by said jurisdiction.

14. The method of claim 13, wherein said jurisdiction further promulgates at least one regulation prohibiting non-lawyers from sharing fees with said plurality of members of said law firm.

15. A computer program product comprising a computer usable medium having control logic stored therein for causing a computer to facilitate the operations of a professional service firm comprised of members who each possesses a license required and issued by a jurisdiction to engage in a professional service, said control logic comprising:
first computer readable program code means for causing the computer to receive information about the amount of investment capital invested into a services company from a plurality of investors;
second computer readable program code means for causing the computer to determine a payment amount due to said services company for rendering at least one of a plurality of services needed to operate said professional service firm; and
third computer readable program code means for causing the computer to determine a distribution amount payable to each of said plurality of investors based in part upon said payment amount due to said services company for rendering said at least one of said plurality of services to said professional services firm;
wherein said plurality of investors are not licensed to practice said professional service provided by said professional service firm; and
wherein said jurisdiction promulgates at least one regulation prohibiting non-licensed persons from being members in said professional service firm.

16. The computer program product of claim 15, wherein said professional service firm is one of: a law firm; an engineering firm; a medical practice; a chiropractic practice; an accounting firm; and an architectural firm.
